(19) United States
(12) Patent Application Publication
(10) Pub. No.: US 2004/0115314 A1
(43) Pub. Date: Jun. 17, 2004

(54) Crunchy wafer product

(75) Inventors: Begum Tamer, Adana (TR); Nazmi Civil, Adana (TR); Golchin Kamalikocyigit, Istanbul (TR)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/645,758

(22) Filed: Aug. 21, 2003

(30) Foreign Application Priority Data
Aug. 30, 2002 (EP) 02019145.8

(51) Int. Cl. A23G 1/00

(52) U.S. Cl. 426/94; 426/306

(57) ABSTRACT

The invention relates to a confectionery product comprising two outer wafer layers, optionally one or more inner wafer layers and cream fillings between the wafer layers, wherein the wafer layers are made from a material which includes cocoa powder. The cocoa wafer layers improve the crunchy texture of the confectionery product.

### STATE OF THE ART

The present invention relates to wafer-based confectionery products which in general comprise two outer wafer layers, optionally one or more inner wafer layers and cream fillings in between. Such wafer-based confectionery products are widely known and well accepted consumer products.

The wafer layers are made from commonly known batter compositions which comprise for example wheat flour, salt, vegetable oil, Lecithin, sodium bicarbonate and water. The wafer layers must have a crunchy texture in order to achieve consumer acceptance. The disadvantage of known wafer-based confectionery products is that the crunchy texture of the wafer layers becomes doughy upon continued chewing. Therefore, there is a demand for improved wafer-based confectionery products.

It is the object of the present invention to provide new wafer-based confectionery products which have a crunchy texture not only at the beginning of consumption, but maintain their crunchy texture upon continued chewing.

### SUMMARY OF THE INVENTION

The object of the present invention is achieved by a confectionery product comprising two outer wafer layers, optionally one or more inner wafer layers and cream fillings between the wafer layers, wherein the wafer layers are made from a material which includes cocoa powder.

It was surprisingly found that the use of cocoa powder in the batter recipe for the wafer layers improves the crunchy texture of the confectionery product such that the crunchy texture is maintained even upon continued chewing compared with known wafer-based confectionery products which lose their crunchiness after being chewed only twice or three times because the wafer layers become doughy.

### DETAILED DESCRIPTION OF THE INVENTION

The present invention is based on the discovery that wafer layers which contain cocoa remain crunchy upon continued chewing. They do not lose the crunchy texture after being chewed twice or three times as is the case with the known is wafer-based products which do not contain cocoa within the wafer layers.

The wafer-based confectionery products which are available on the market are relatively small in size compared with the form and dimensions of a regular chocolate bar. It was found within the present invention that the eating pleasure and the product performance with respect to its crunchiness is greatly improved if the dimensions of the wafer-based confectionery product are increased. Therefore, the products of the present invention preferably have the form and dimensions of a regular chocolate bar. Regular chocolate bars normally have the following dimensions:

length: about 90 mm,

width: about 30 mm,

height: about 21 mm.

No such wafer-based confectionery product is available on the market.

The products of the present invention preferably have six or seven wafer layers and correspondingly five or six cream filling layers. Furthermore, the products of the invention are preferably enrobed with chocolate.

Batter recipes for making wafer sheets are widely known in the prior art. A common wafer batter comprises for example wheat flour, salt, vegetable oil, Lecithin, sodium bicarbonate and water. For example, the following batter recipe can be used for making the wafer sheets according to the present invention:

| | | |
|---|---|---|
| Water | 54-58% | by weight |
| Wheat flour | 36-39% | by weight |
| Salt | 0.6-0.9% | by weight |
| Vegetable oil | 1.5-1.8% | by weight |
| Lecithin | 0.2-0.3% | by weight |
| Sodium bicarbonate | 0.05-0.07% | by weight |
| Cocoa powder | 1-10% | by weight |

The cocoa powder is preferably used in amounts of 2-8% by weight, especially 3-6% by weight.

The cocoa powder can be of any origin. Preferably Ivory Coast cocoa powder is used.

In a first step for producing the wafer-based confectionery products of the present invention, the ingredients of the batter recipe are mixed together in any convenient mixing device. The viscosity as measured in a Ford Cup like viscosimeter should be about 39-42 sec (flow out time) at 18 to 20° C.

The obtained batter is then used for baking wafer sheets in a commonly used wafer baking equipment. The wafer sheets have dimensions which are designed according to the requirements of the end product. Because of the cocoa content, the weight of the wafer sheets increases to some extent. Based on a wafer area of 1,300 cm² and a wafer thickness of 3.0 mm, the weight increases up to about 60 g compared with 54 g for corresponding wafer sheets containing no cocoa powder. The moisutre content of the wafer sheets should be about 0.8 to 1.2% by weight.

The wafer sheets are then spread with cream and stacked on top of each other as per product format. This form is called a wafer book.

Any known or useful cream can be used for the cream fillings. There is no limitation whatsoever except that the cream viscosity must be such that the cream can be set at ambient temperatures.

As the next step, the wafer book is cooled to set the cream before cutting. Afterwards, the wafer book is divided into a prescribed number of pieces in a common cutting station. Then, after cutting, the wafer pieces are enrobed with chocolate and then cooled, for example, in a cooling tunnel, to set the final crystal structure of chocolate.

Finally, the product is packaged according to common standard procedures in any suitable foil.

The following example is illustrative of the invention and is not intended as limiting.

### EXAMPLE

As a first step in the production of the new wafer-based confectionery product, wafer sheets were produced from the following materials including dark cocoa powder:

| | |
|---|---|
| Water | 75.00 kg |
| Wheat flour | 50.00 kg |
| Salt | 1.00 kg |
| Vegetable oil | 2.20 kg |
| Lecithin | 0.35 kg |
| Sodium bicarbonate | 0.08 kg |
| Cocoa powder | 5.00 kg |
| (10/12 alkanized) | |
| Total batch | 133.63 kg |

To produce the batter, the ingredients were mixed in a Hebenstreit mixer according to the following procedure:

| Ingredients | Mixing time |
|---|---|
| Water (1/2) | 15 sec. |
| Sodium bicarbonate | |
| Salt | |
| Wheat flour | 60 sec. |
| Cocoa powder | |
| Water (1/2) | |
| Lecithin | 60 sec. |
| Vegetable oil | |

The viscosity of the batter was 39 sec.

Wafer sheets were baked from the obtained batter in a common wafer baking equipment. Baking time was 1.8 minutes. The weight of the wafer sheets increased to 61±2 g per 1,300 cm² (from 54 g without cocoa powder). The moisture content was 0.9% by weight.

The wafer sheets were then spread with cream and stacked on top of each other to produce the so-called wafer book, which was cooled afterwards to set the cream before cutting. The wafer book was then divided into the prescribed number of pieces in the cutting station. The obtained wafer bars were enrobed with chocolate and conveyed to a cooling tunnel to set the final chocolate crystal structure.

The wafer products had the following form and dimensions:

6 layers of wafer sheet
5 layers of cream filling
Milk chocolate coating

| | |
|---|---|
| Length: | 92 mm |
| Width: | 30 mm |
| Height: | 21 mm |

When compared with commercially available wafer-based confectionery products, the wafer products of the present invention had an excellent crunchy texture and maintained the crunchiness upon continued chewing. The commercially available wafer-based confectionery products lost their original crunchiness upon chewing and became doughy.

What is claimed is:

1. A confectionary product comprising two outer wafer layers, wherein the wafer layers are made from a batter material which includes cocoa powder.

2. The confectionary product of claim 1, wherein the confectionary product includes one or more inner wafer layers and cream fillings between the wafer layers.

3. The confectionary product of claim 1, wherein the product has a form and dimensions of a regular chocolate bar.

4. The confectionary product of claim 2, wherein the product includes 6 or 7 wafer layers and correspondingly 5 or 6 cream filling layers.

5. The confectionary product of claim 1, wherein the product is enrobed with chocolate.

6. A confectionary product comprising:
two outer wafer layers; and
at least one inner wafer layer,
wherein the wafer layer includes 1 to 10% by weight cocoa powder.

7. The confectionary product of claim 6, wherein the wafer layers are formed from a batter comprising:
from 36 to 39% by weight flour;
from 0.6 to 0.9% by weight salt;
from 1.5 to 1.8% by weight vegetable oil;
from 0.2 to 0.3% by weight Lecithin;
from 0.05 to 0.07% by weight bicarbonate;
from 1 to 10% by weight cocoa powder; and
from 54 to 58% by weight water.

8. The confectionary product of claim 7, wherein the wafer layer indicates 2 to 8% by weight cocoa powder.

9. The confectionary product of claim 8, wherein the wafer includes 3 to 6% by weight cocoa powder.

10. The confectionary product of claim 6, wherein the confectionary product includes cream filling between the wafer layers.

11. The confectionary product of claim 6, wherein the confectionary product is enrobed with chocolate.

12. A method for producing a wafer comprising blending a wafer batter with from 1 to 10% by weight cocoa powder to a viscosity as measured in a Ford cup like viscosimeter to a flow out time of at least 39 at a temperature of 18 to 20° C.

13. The method of claim 12, wherein the wafer batter comprises:
from 36 to 39% by weight flour;
from 0.6 to 0.9% by weight salt;
from 1.5 to 1.8% by weight vegetable oil;
from 0.2 to 0.3% by weight Lecithin;
from 0.05 to 0.07% by weight bicarbonate;
from 1 to 10% by weight cocoa powder; and
from 54 to 58% by weight water.

14. The method of claim 13, wherein the wafer batter includes 2 to 8% by weight cocoa powder.

15. The method of claim 14, wherein the wafer batter includes 3 to 6% by weight cocoa powder.

16. A method for producing a confectionary product comprising:
blending a wafer batter with from 1 to 10% by weight cocoa powder;
baking the wafer batter to form a wafer; and
stacking the wafers together with a filling between the wafers.

17. The method of claim 16, wherein the wafer batter comprises:
from 36 to 39% by weight flour;
from 0.6 to 0.9% by weight salt;
from 1.5 to 1.8% by weight vegetable oil;
from 0.2 to 0.3% by weight Lecithin;
from 0.05 to 0.07% by weight bicarbonate;
from 1 to 10% by weight cocoa powder; and
from 54 to 58% by weight water.

18. The method of claim 17, wherein the wafer batter includes 2 to 8% by weight cocoa powder.

19. The method of claim 18, wherein the wafer batter includes 3 to 6% by weight cocoa powder.

20. The method of claim 16, wherein the confectionary product is enrobed with chocolate.
